(19) United States
(12) Patent Application Publication
(10) Pub. No.: US 2008/0011135 A1
(43) Pub. Date: Jan. 17, 2008

(54) GEAR DRIVEN PUNCH KNOCK OUT DRIVER

(76) Inventor: Brian Ray, Gilbert, AZ (US)

Correspondence Address: SCHMEISER OLSEN & WATTS, 18 E UNIVERSITY DRIVE, SUITE # 101, MESA, AZ, 85201, US

(21) Appl. No.: 11/623,419

(22) Filed: Jan. 16, 2007

Related U.S. Application Data
(60) Provisional application No. 60/806,985, filed on Jul. 11, 2006.

(51) Int. Cl. B26F 1/14

(52) U.S. Cl. 83/55; 83/686

(57) ABSTRACT

A knockout driver includes an inner chamber with an actuator mounted for rotational movement therein. A gripper is engaged with the actuator and moves linearly through the inner chamber in response to the actuator being rotated. The rotational movement of the gripper is restricted when the actuator rotates to reduce the amount of torque applied to the user.

### CROSS-REFERENCES TO RELATED APPLICATIONS

The present application claims priority to U.S. Provisional Application Ser. No. 60/806,985, filed on Jul. 11, 2006 by the same inventor, the entirety of which is incorporated herein by reference.

### BACKGROUND OF THE INVENTION

1. Field of the Invention

This invention relates to tools and, more particularly, to punch knockout drivers for driving a hole through a work piece.

2. Description of the Related Art

Knockout drivers are generally used to make holes in work pieces, such as sheet metal. They do this by transferring a large force through the surface of the work piece. Knockout drivers can be powered in many different ways. For example, large industrial punch knock out drivers are typically powered hydraulically or pneumatically. Smaller knockout drivers are typically operated manually, although there are some that can be operated with an electric hand drill, as disclosed in U.S. Pat. No. 4,495,699.

One limitation associated with industrial knockout drivers is their limited mobility, such as when connected with a hose to a hydraulic or pneumatic pump. Furthermore, hydraulic and pneumatic powered knockout drivers are large and expensive. Thus, a small company or individual may not be able to afford the cost of purchasing such a tool and may not have the space to operate it.

There are several limitations in operating knockout drivers manually. For example, it is difficult to punch through work pieces made of hard materials and it is difficult to accurately make a number of holes. Further, the effectiveness of manually operated knockout drivers is often determined by the strength and abilities of the user. For example, torque is applied to the driver when a hole is formed and this torque is countered by the user of the knockout driver. The torque increases with the size of the hole and it is much more difficult to form the hole if the torque cannot be countered.

### BRIEF SUMMARY OF THE INVENTION

The present invention employs a knockout driver which includes a housing having an inner chamber. The driver also includes an actuator mounted for rotational movement in the inner chamber. A gripper is threadingly engaged with the actuator and moves through the inner chamber in response to the actuator being rotated. The rotational movement of the gripper is restricted when the actuator rotates and this restricts the amount of torque transferred to the user. This is useful because the knockout driver can be used to form larger dimension holes without subjecting the user to a corresponding increase in torque.

These and other features, aspects, and advantages of the present invention will become better understood with reference to the following drawings and description.

### BRIEF DESCRIPTION OF THE DRAWINGS

FIG. 1A is a perspective view of a knockout driver, in accordance with the invention.

FIG. 1B is a side view of the knockout driver of FIG. 1A.

FIG. 2 is a perspective view of an input shaft and gear included with the knockout driver of FIGS. 1A and 1B.

FIG. 3 is a cross-sectional view of the knockout driver of FIGS. 1A and 1B, taken along a cut-line 3-3′ of FIG. 1B.

FIG. 4 is a cross-sectional view of the knockout driver of FIGS. 1A and 1B, taken along a cut-line 4-4′ of FIG. 1B.

FIG. 5 is a side view of a die set for use with the knockout driver of FIGS. 1A and 1B.

FIGS. 6A an 6B are side views of the knockout driver of FIGS. 1A and 1B in disengaged and engaged positions, respectively, relative to the die set of FIG. 5.

FIGS. 7A, 7B and 7C are side views of the knockout driver of FIGS. 1A and 1B moving between extended, cutting and retracted positions, in accordance with the invention.

### DETAILED DESCRIPTION OF THE INVENTION

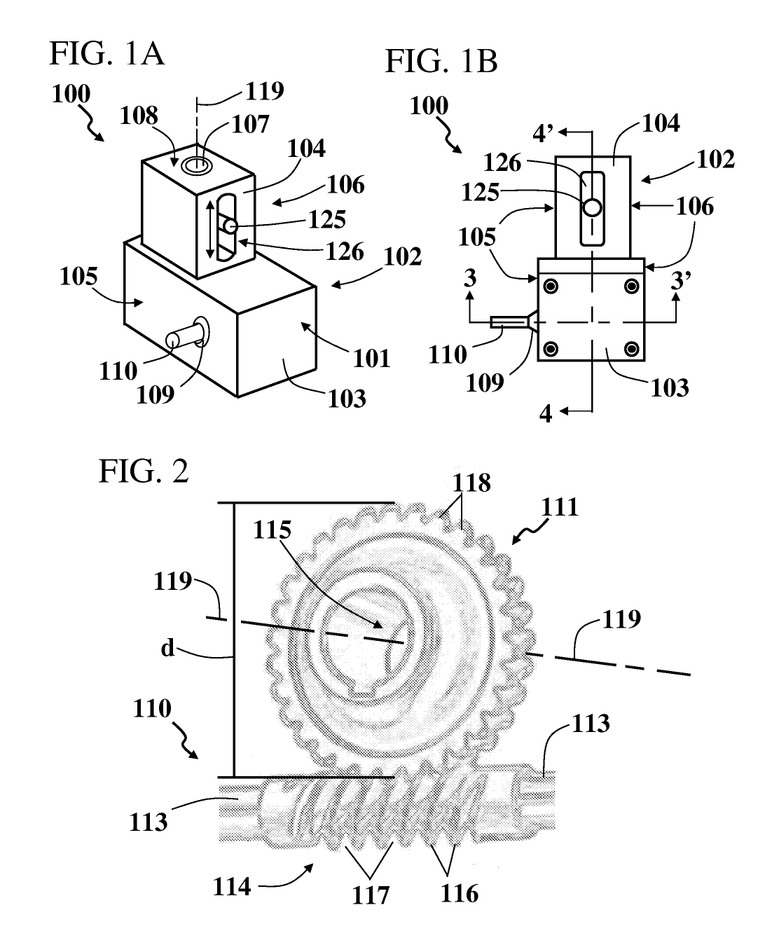

FIG. 1A is a perspective view of a knockout driver 100, in accordance with the invention, and FIG. 1B is a side view of driver 100 when looking in a direction 101. In this embodiment, driver 100 includes a housing 102 made of a single piece but, in general, it can be made of one or more pieces. If housing 102 is made of more than one piece, the pieces can be permanently attached together to form a single integrated housing. In other embodiments, the pieces can be attached to and detached from each other in a repeatable manner. However, a housing made of one piece is generally stronger than a housing made of two or more pieces. A housing made of two or more pieces is generally easier to manufacture and provide with a desired shape. Housing 102 can have many different shapes, but here it is “L” shaped and has a horizontal portion 103 and a vertical portion 104 extending upwardly therefrom. It is useful to make housing 102 of a hard and strong material, such as hardened steel, to protect the components housed inside of it, some of which will be discussed presently.

FIG. 2 is a perspective view of an input shaft 110 and a gear 111, which are components included in knockout driver 100. In this embodiment, input shaft 110 extends outwardly through an opening 109 which extends through a side 105 of housing 102 (FIG. 1A). Shaft 110 includes unthreaded shaft portions 113 and a threaded shaft portion 114 so it operates as a worm shaft. Threaded shaft portion 114 includes helically progressive walls 116 spaced from each other by grooves 117. Walls 116 and grooves 117 are chosen so that threaded shaft portion 114 has a desired number of threads per unit length (i.e. threads per inch), which is chosen to match the teeth of gear 111, as will be discussed presently.

In this embodiment, gear 111 is circular in shape and includes an opening 115 extending through it. Opening 115 faces upwardly and is aligned with an opening 107 of housing 102 (FIG. 1A). Opening 107 extends through a side 108 at the top of vertical portion 104 and into a chamber 130 (FIG. 4). Side 108 extends between side 105 and an opposed side 106 of housing 102. Gear 111 also includes teeth 118 positioned around its outer periphery for engaging threaded shaft portion 114. In this way, gear 111 and input shaft 110 are operatively coupled together so that gear 111 rotates in response to the rotation of input shaft 110. The rotation of gear 111 is around a rotation axis 119 which extends through opening 107 (FIG. 1A) and opening 115 (FIG. 2).

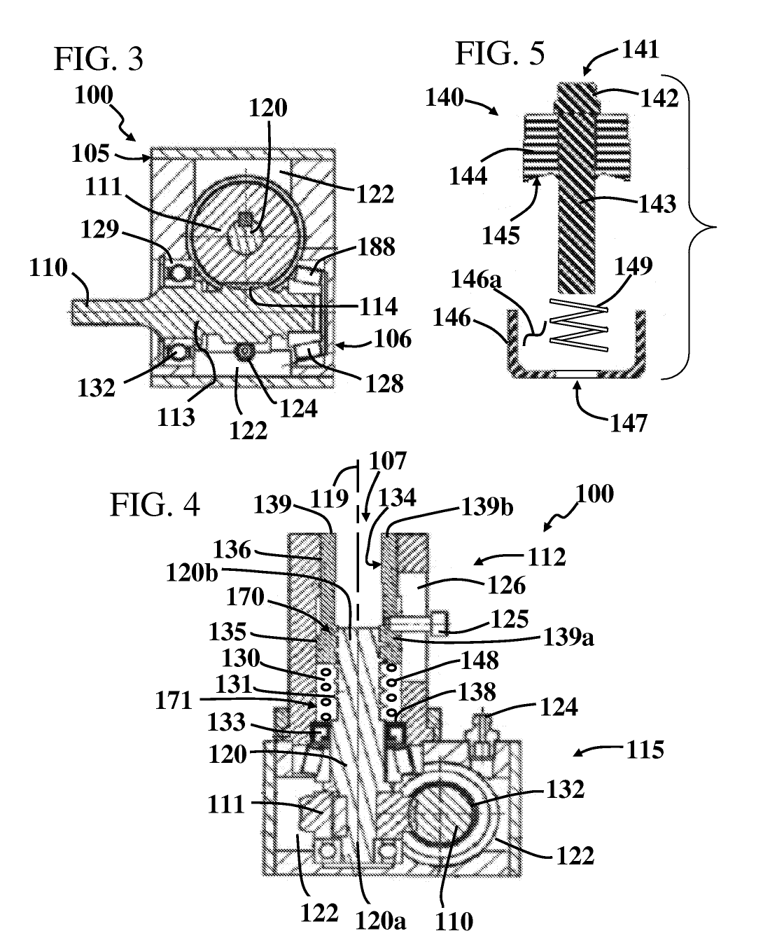

FIGS. 3 and 4 are cross-sectional views of knockout driver 100 taken along cut-lines 3-3′ and 4-4′, respectively, of FIG. 1B. In this embodiment, input shaft 110 is supported in housing 102 so that threaded shaft portion 114 is able to rotate therein. Input shaft 110 can be supported in several different ways, but in this embodiment it is supported by engaging a proximal end of unthreaded shaft portion 113 with a bearing 128 and an intermediate portion of unthreaded shaft portion 113 with a bearing 129. Bearing 129 is positioned in housing 102 near opening 109 so that threaded shaft portion 114 is positioned between bearings 128 and 129. A distal end of input shaft 110 extends out of housing 110.

In this embodiment, knockout driver 100 includes an actuator 120 with a proximal end 120a operatively coupled with gear 111. Gear 111 and actuator 120 can be operatively coupled together in many different ways, but in this embodiment, actuator 120 extends through opening 115 and engages gear 111 therein. Actuator 120 is positioned so its axis of rotation corresponds with axis 119 (FIGS. 1A, 2 and 4). Hence, actuator 120 has a common axis of rotation with gear 111 and rotates in response to the rotation of input shaft 110 and gear 111. In this way, actuator 120 is operatively coupled with input shaft 110 and gear 111.

In accordance with the invention, a distal end 120b of actuator 120 is in chamber 130 and includes threads 131 which threadingly engage a proximal end 139a of a gripper 139 in a region 170. Threads 131 can be of many different types, such as acme threads. In general, actuator 120 applies more torque to gripper 139 as the threads are closer together. Further, actuator 120 applies less torque to gripper 139 as the threads are spaced farther apart. Actuator 120 also applies more torque to gripper 139 as its diameter decreases and applies less torque to gripper 139 its diameter increases. The diameter of actuator 120 is determined by that of its cross-sectional area, which extends perpendicular to axis 119.

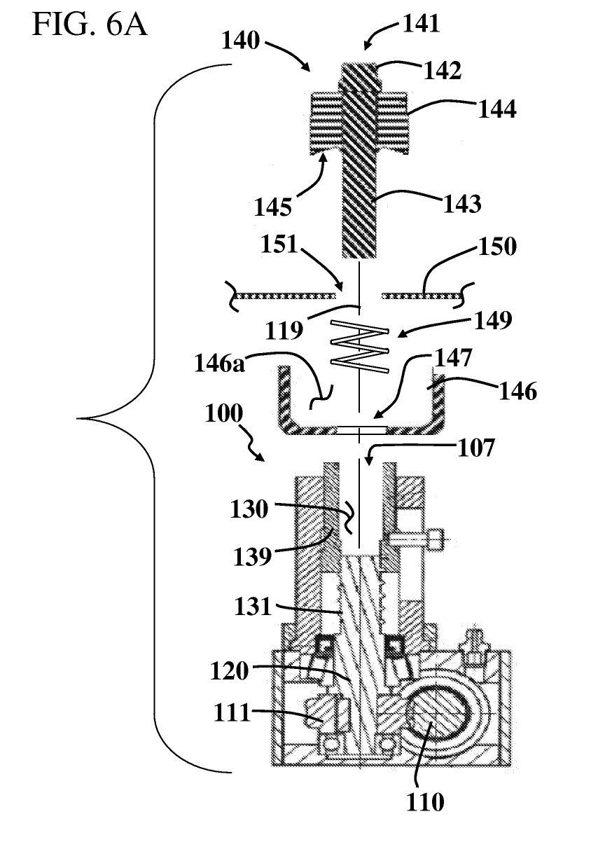

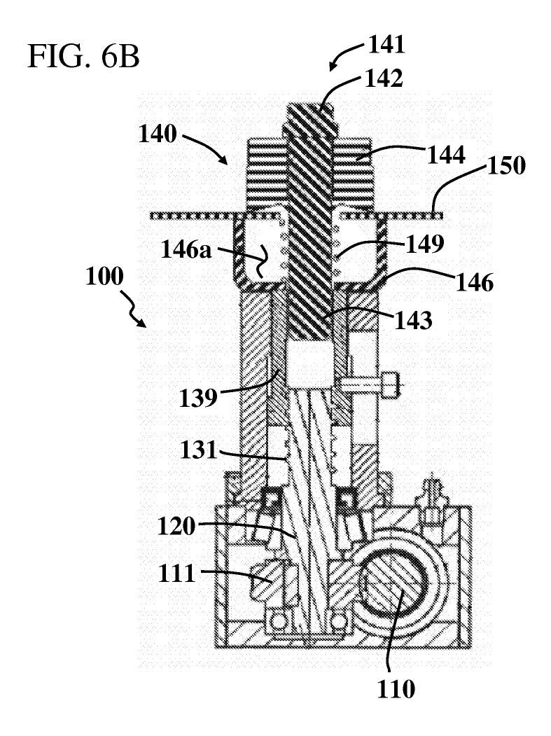

In this embodiment, gripper 139 has the shape of a hollow cylinder with a threaded inner surface 134. Gripper 139 is shaped and dimensioned to extend through opening 107 so that its outer periphery slidably engages a sidewall 171 of chamber 130. Sidewall 171 guides the linear movement of gripper 139 through chamber 130. Threaded inner surface 134 engages threads 131 so that actuator 120 and gripper 139 are threadingly engaged together in region 170. Region 170 is within chamber 130 to reduce the likelihood of it being damaged or contaminated with debris. Threaded inner surface 134 near a distal end 139b of gripper 139 is for engaging a bolt, as will be discussed in more detail with FIGS. 6A and 6B.

Threaded inner surface 134 has a pitch chosen to provide a desired linear force along axis 119 to gripper 139 when actuator 120 is rotated. As the pitch of threaded inner surface 134 increases, gripper 139 moves slower and the force provided by its movement is larger. As the pitch of threaded inner surface 134 decreases, gripper 139 moves faster and the force provided by its movement is smaller.

Further, the linear force provided by the movement of gripper 139 through inner chamber 130 depends on the number of teeth 118 of gear 111 and/or the threads per unit length of threaded portion 114. As the number of teeth and/or threads per unit length increases, the amount of linear force decreases. As the number of teeth and/or threads per unit length decreases, the amount of linear force increases.

In this embodiment, gripper 139 includes a gripper protrusion 135 near its proximal end 139a. Further, housing 102 includes a chamber protrusion 136 extending into chamber 130 near opening 107. In this embodiment, protrusions 135 and 136 are annular, but they can have other shapes. Protrusions 135 and 136 are useful to prevent gripper 139 from being undesirably ejected out of chamber 130 during its movement. Gripper 139 is prevented from being ejected because gripper protrusion 135 engages chamber protrusion 136 as gripper 139 is moved out of chamber 130 through opening 107. In this way, the linear movement of gripper 139 in chamber 130 is restricted.

In this embodiment, a spring 148 is positioned in chamber 130 and around actuator shaft 120. Spring 148 is positioned to engage gripper 139 and a bottom surface 138 of chamber 130 so that there is a spring force between them. Spring 148 provides a counter force to gripper 139 which inhibits it from being disengaged from threads 131 on actuator shaft 120. Spring 148 can also urge threaded surface 134 to re-engage threads 131 if they become disengaged.

In operation, the rotation of actuator shaft 120 in one direction around axis 119 causes gripper 139 to move linearly through chamber 130 against the force of spring 148 and towards bottom surface 138. The rotation of actuator shaft 120 in an opposed direction around axis 119 causes gripper 139 to move linearly through chamber 130 with the force of spring 148 and away from bottom surface 138.

In an extended position, distal end 139b of gripper 139 is out of chamber 130 and, in a retracted position, distal end 139b is in chamber 130. It is useful to have gripper 139 in the extended position when it is desirable to engage it with a die set. Further, it is desirable to have gripper 139 in the retracted position when it is being stored or when driving an opening through a work piece. When being stored, distal end 139b is less likely to be damaged or contaminated with debris when it is in chamber 130.

Gripper 139 is moved from the extended position to the retracted position when it is moved towards bottom surface 138 and distal end 139b moves from outside of chamber 130 to inside of it. Gripper protrusion 135 is moved away from chamber protrusion 136 when gripper 139 is moved from the extended position to the retracted position. Further, gripper 139 is moved from the retracted position to the extended position when it is moved away from bottom surface 138 and distal end 139b is moved from inside of chamber 130 to outside of it. Gripper protrusion 135 is moved towards chamber protrusion 136 when gripper 139 is moved from the retracted position to the extended position.

In accordance with the invention, gripper 139 is free to move linearly in a direction parallel with axis 119, but its rotational movement around axis 119 is restricted to reduce the amount of torque transferred through input shaft 110 to the user. The amount of torque depends on many different parameters, such as the hardness of the work piece and the diameter of the opening to be driven through it. This feature is useful so that knockout driver 100 can be used to form larger dimension holes.

The rotational movement of gripper 139 can be restricted in many different ways, such as with housing 102. In this embodiment, knockout driver 100 includes a rotation restrictor, embodied as a set screw 125, which extends through a keyway 126 of vertical portion 106 (FIGS. 1A and 1B). Keyway 126 extends along vertical portion 106 in a direction parallel to axis 119. Set screw 125 is perpendicular to gripper 139 and axis 119, and moves in keyway 126 in response to the movement of gripper 139 in chamber 130. Keyway 126 is shaped so that it allows set screw 125 to move parallel to axis 119 but has sidewalls which restrict the rotational movement of set screw 125 around axis 119. In this way, gripper 139 can move linearly along axis 119 but is restricted from rotating about it. It should be noted that set screw 125 is housed within housing 102 in some embodiments, but here set screw 125 extends outside of it.

In this embodiment, the rotation of shaft 110 and gear 111 in housing 102 is facilitated by including a reservoir 122 therein to hold a lubricant. The lubricant reduces the friction between threaded shaft portion 114 and teeth 118, as well as between unthreaded shaft portion 113 and bearings 128 and 129. A fluid conduit 124 is in fluid communication with reservoir 122 so that fluid can be injected into it.

In this embodiment, driver 100 includes seals to reduce the undesirable flow of the lubricant out of reservoir 122. For example, a seal 132 is positioned around shaft 110 near bearing 129 and provides a seal between reservoir 122 and regions external to reservoir 122. A seal 133 is positioned around actuator shaft 120 and provides a seal between reservoir 122 and chamber 130. Actuator shaft 120 extends between horizontal portion 105 and vertical portion 106 through seal 133 so that its distal end is towards opening 107. Seals 132 and 133 can be made of many different materials, but here they are made of a durable rubber material. In some embodiments, reservoir 122 includes self lubricating materials so the need to add lubricant is reduced.

FIG. 5 is a side view of a die set 140 which can be used with driver 100 to form a hole through a work piece. In this embodiment, set 140 includes a bolt 141 having a head 142 connected to one end of a shaft 143. Set 140 also includes a cylindrically shaped die cutter 144 having an opening extending through it and sized and shaped to receive shaft 143. Die cutter 144 has a side 145 shaped to operate as a cutter and an opposed side shaped to engage head 142. Cutting side 145 is used to cut an opening through the work piece.

In this embodiment, die set 140 also includes a die container 146 used to receive die cutter 144 after it cuts through the work piece. Die container 146, as well as bolt 141 and die cutter 144, can be made of many different materials, such as hardened steel. Die container 146 includes an opening 147 sized and dimensioned to receive shaft 143. In some embodiments, die container 146 is attached to driver 100, but in this embodiment, it is a separate piece.

In some embodiments, die set 140 includes a spring 149 positioned so that shaft 143 extends through it and opening 147. In this way, spring 149 provides a spring force between die cutter 144 and die container 146. The distal end of shaft 143 is adapted to be gripped by gripper 139. This can be done in many different ways, one of which will be discussed presently.

FIGS. 6A and 6B are side views of driver 100 in disengaged and engaged positions, respectively, relative to die set 140. Driver 100 can be moved from the engaged position to the disengaged position relative to die set 140 in many different ways. In one way, bolt 143 and die 144 are on one side of a work piece 150 and driver 100, die container 146 and spring 149 are on an opposed side. Work piece 150 has a hole 151 extending therethrough, and is shaped and dimensioned to receive shaft 143. Hole 151 can be formed in many different ways, such as with a drill, and is preformed to allow the placement of a die cutter 143 on work piece 150.

In this embodiment, die container 146 and spring 149 are positioned on the opposed side of work piece 150 and spring 149 and opening 147 are aligned with hole 151. Spring 149 is positioned within a space 146a of container 146 and between work piece 150 and die container 146. Shaft 143 is inserted through hole 151, as well as spring 149 and opening 147, so that cutting side 145 engages work piece 150. Gripper 139 is in its extended position and distal end 120b of actuator 110 is threadingly engaged with gripper 139. Gripper 139 is moved from the extended position towards the retracted position in response to the rotation of shaft 110, as discussed above, so that die cutter 144 is held to work piece 150 between head 142 and gripper 139 (FIG. 6B). In this way, driver 100 is moved from a disengaged position to an engaged position relative to die set 140. It should be noted that the movement distance of gripper 139 through chamber 130 between the extended and retracted positions is about one quarter to three quarters of an inch, although the distance can be outside of this range.

It should also be noted that driver 100 can be moved from the engaged position to the disengaged position relative to die set 140 in many different ways. In one way, the above steps are reversed. In another way, die cutter 144 is used to drive an opening larger than hole 151 through work piece 150, as will be discussed in more detail presently.

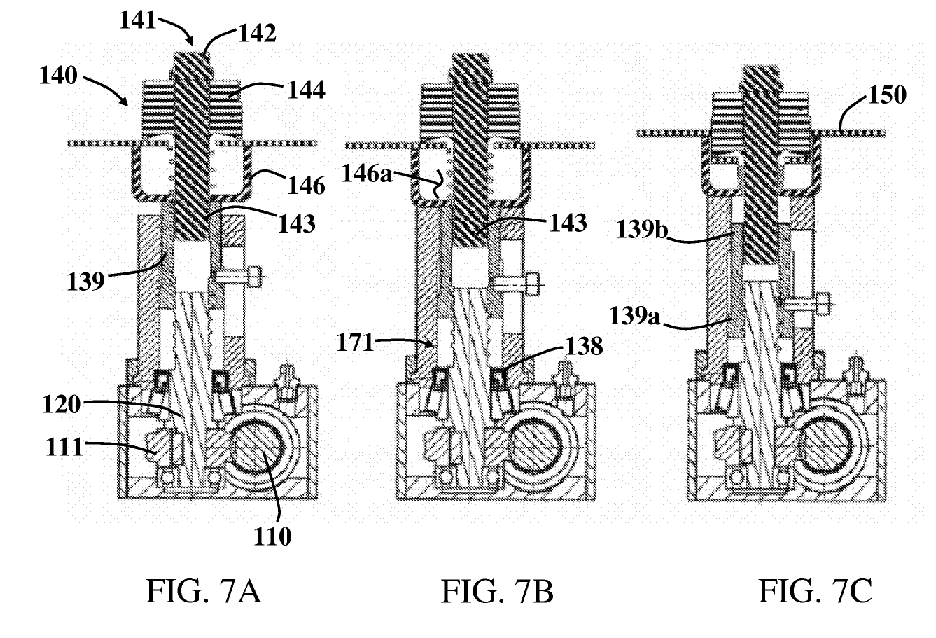

FIGS. 7A, 7B and 7C are side views of driver 100 moving between extended, cutting and retracted positions, in accordance with the invention, relative to work piece 150. As shown in FIG. 7A, driver 100 is in its extended position wherein distal end 139b of gripper 139 is outside of chamber 130 and engaged with die set 140, as discussed with FIGS. 6A and 6B.

As shown in FIG. 7B, shaft 110 is rotated so that gripper 139 moves into chamber 130 and pulls shaft 143 along with it. In response, die cutter 144 moves towards die container 146 and cuts through the surface of work piece 150. As shaft 110 is further rotated, enough force is provided by gripper 139 to cause die cutter 144 to cut through work piece 150, as shown in FIG. 7C. Input shaft 110 is rotated until die cutter 144 extends through work piece 150 to form a hole therethrough. In this way, driver 100 is used to drive a hole through work piece 150. It should be noted that input shaft can be rotated in many different ways, such as manually. However, in this embodiment, it is rotated by activating an electric drill coupled to it.

As mentioned previously, the rotational movement of gripper 139 is restricted when actuator 120 rotates. The restriction of gripper 139 restricts the amount of torque transferred to the user. This allows knockout driver 100 to be used to form larger dimension holes. For example, knockout driver 100 can be used to form openings with a diameter larger than two and one-half inches. Knockout driver 100 can be used to form openings with a diameter in a range between about two and one-half inches to about four inches.

The embodiments of the invention described herein are exemplary and numerous modifications, variations and rearrangements can be readily envisioned to achieve substantially equivalent results, all of which are intended to be embraced within the spirit and scope of the invention.

1. A knockout driver having an inner chamber, the driver comprising:
an actuator mounted for rotational movement in the inner chamber; and
a gripper engaged with the actuator, the gripper moving through the inner chamber in response to the actuator being rotated.

2. The driver of claim 1, wherein a distal end of the gripper is moveable between positions inside and outside the chamber.

3. The driver of claim 1, wherein the engagement of the gripper and actuator occurs within the inner chamber.

4. The driver of claim 1, wherein the inner chamber has a sidewall that guides the movement of the gripper.

5. The driver of claim 1, wherein rotational movement of the gripper is restricted when the actuator rotates.

6. The driver of claim 1, further including a gear operatively coupled with the actuator, the force provided by the movement of the gripper through the inner chamber depending on the number of teeth of the gear.

7. The driver of claim 1, wherein the gripper and actuator are threadingly engaged together.

8. A knockout driver having an inner chamber extending through a housing, the driver comprising:
an actuator extending through the inner chamber and mounted for rotational movement therein; and
a gripper threadingly engaged with a distal end of the actuator, wherein rotational movement of the gripper is restricted when the actuator rotates.

9. The driver of claim 8, wherein the gripper moves through the inner chamber in response to the actuator being rotated.

10. The driver of claim 8, further including a rotation restrictor which engages the housing to restrict the rotational movement of the gripper.

11. The driver of claim 8, further including a gripper protrusion near a proximal end of the gripper and a chamber protrusion extending into the chamber near an opening of the inner chamber.

12. The driver of claim 8, wherein a diameter of the actuator is chosen to provide the gripper with a desired amount of torque.

13. The driver of claim 8, further including a spring which applies a spring force to the gripper.

14. The driver of claim 13, further including a gear operatively coupled with the actuator, a force provided by linear movement of the gripper depending on the number of teeth of the gear and the spring force provided by the spring.

15. The driver of claim 8, further including a gear operatively coupled with the actuator, wherein an amount of rotational force restricted by the housing depends on the number of teeth of the gear.

16. The driver of claim 8, further including a gear having a number of teeth chosen to provide the gripper with a desired linear force when the actuator is rotated.

17. A method of forming a hole through a work piece, comprising:
engaging a die cutter with the work piece;
providing a knockout driver and coupling it with the die cutter, the knockout driver including a gripper engaged with an actuator;
rotating the actuator so the gripper pulls the die cutter through the work piece to form the hole.

18. The method of claim 17, further including restricting rotational movement of the gripper in response to rotating the actuator.

19. The method of claim 17, further including moving a distal end of the gripper from a position outside a chamber of the knockout driver to one inside of it.

20. The method of claim 17, further including moving the gripper against a spring force of a spring.
